(19) United States
(12) Patent Application Publication
(10) Pub. No.: US 2019/0050902 A1
(43) Pub. Date: Feb. 14, 2019

(54) SYSTEMS, DEVICES, AND METHODS FOR AUTOMATICALLY TRIGGERING UNSOLICITED EVENTS IN RESPONSE TO DETECTION OF USERS

(71) Applicant: Walmart Apollo, LLC, Bentonville, AR (US)

(72) Inventors: Nicholaus Adam Jones, Fayetteville, AR (US); Aaron James Vasgaard, Fayetteville, AR (US); Matthew Allen Jones, Bentonville, AR (US)

(21) Appl. No.: 16/059,274

(22) Filed: Aug. 9, 2018

Related U.S. Application Data
(60) Provisional application No. 62/543,068, filed on Aug. 9, 2017.

(51) Int. Cl. G06Q 30/02

(52) U.S. Cl. CPC G06Q 30/0261; G06Q 30/0255; G06Q 30/0226

(57) ABSTRACT

Methodologies, systems, and computer-readable media are provided for automatically triggering predictive events in a facility in response to user detection. Once an individual enters or approaches a facility, location and identification data can be received from a mobile device associated with the individual. The location of the individual and the individual's identity can be determined, and a computing system can access an account associated with the individual. The computing system can trigger the a predictive event, such as the preparation of a product that the individual is likely to purchase, and a notification can be sent to the individual's mobile device once the predictive event is complete. The predictive event can be based on the individual's previous purchase or service history.

### CROSS-REFERENCE TO RELATED PATENT APPLICATIONS

This application claims priority to U.S. Provisional Application No. 62/543,068 filed on, Aug. 9, 2017, the content which is hereby incorporated by reference in its entirety.

### BACKGROUND

Event-driven utilization of resources in a facility can be difficult to manage, and ensuring availability of resources and efficient use of resource poses several challenges.

### BRIEF DESCRIPTION OF THE DRAWINGS

The skilled artisan will understand that the drawings are primarily for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

The foregoing and other features and advantages provided by the present disclosure will be more fully understood from the following description of exemplary embodiments when read together with the accompanying drawings, in which:

FIG. 1 is a flowchart illustrating an exemplary method for automatically triggering predictive events in response to user detection, according to an exemplary embodiment.

FIG. 2 is a flowchart illustrating another exemplary method for automatically triggering predictive events in response to user detection, according to an exemplary embodiment.

FIG. 3 is a flowchart illustrating another exemplary method for automatically triggering predictive events in response to user detection, according to an exemplary embodiment.

FIG. 4 is a block diagram illustrating an autonomous robot device in a facility according to an exemplary embodiment of the present disclosure.

FIG. 5 is a diagram of an exemplary network environment suitable for a distributed implementation of an exemplary embodiment.

FIG. 6 is a block diagram of an exemplary computing device that can be used to perform exemplary processes in accordance with an exemplary embodiment.

### DETAILED DESCRIPTION

Following below are more detailed descriptions of various concepts related to, and embodiments of, inventive methods, apparatus, and systems for automatically triggering predictive events in response to user detection. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

As used herein, the term “includes” means “includes but is not limited to”, the term “including” means “including but not limited to”. The term “based on” means “based at least in part on”.

In exemplary embodiments, a user of the mobile electronic device can opt in or out of a mobile app or program configured to notify a remote computing system associated with a facility such as a retail store, whenever the user approaches or enters a particular facility. The user of the mobile device can opt in for products and services to be provided to the user automatically based on the user's location and purchase history.

A remote computing system can be used to receive location data and identification data associated with a mobile electronic device, in response to executing an application associated with the remote computing system. In some embodiments, the location data and identification data can be received initially at a local computing system at a known facility location where the mobile electronic device is located, and the local computing system can transmit the location data and identification data to the remote computing system. The remote computing system can determine the location of the mobile electronic device, as well as the identity of an individual associated with the mobile electronic device, based on the location data and identification data. In some embodiments, the individual associated with the mobile electronic device can create a personalized online account, or configure a mobile application to provide location information and identification information to the remote computing system and/or the local computing system once the individual approaches or enters facility. Once the individual has been identified, the remote computing system accesses a personal account associated with the individual to retrieve personal account data. This personal account data can include, for example, data associated with past interactions with the individual.

The local computing system can determine whether to approve the instructions received from the remote computing system based on contemporaneously determined factors/parameters associated with the local facility (e.g., whether the facility has the capacity to perform the predictive event within a specified time period). If the instructions are approved by the local computing system, the local computing system can automatically trigger the predictive event and transmit a notification to the mobile electronic device of the user once the predictive event is triggered or completed.

In exemplary embodiments, the mobile electronic device associated with the individual can display the notification indicating that the predictive event has been triggered or completed. The mobile electronic device can also allow the individual to accept or decline the predictive event using the mobile electronic device, in some embodiments. If the individual accepts the predictive event, the outcome of the event can be made available to the individual. If, however, the individual declines the predictive event, the outcome (products or services generated based on the predictive event) of the event can be made available to the general public or provided to a second individual. In some embodiments, the local computing system and the remote computing system can communicate with the mobile electronic devices of a number of individuals and can determine which among them is more likely to want the outcome of the event. This may be determined by accessing the private accounts of those individuals and comparing the outcome of the event with the personal account data of each individual. Once an individual has been identified who may be interested in the outcome of the event, the local computing system can transmit a notification to that individual indicating that the event has been triggered or completed. In one embodiment, in response to triggering the event to be completed, an autonomous robot device can complete the event.

Exemplary embodiments are described below with reference to the drawings. One of ordinary skill in the art will recognize that exemplary embodiments are not limited to the illustrative embodiments, and that components of exemplary systems, devices and methods are not limited to the illustrative embodiments described below.

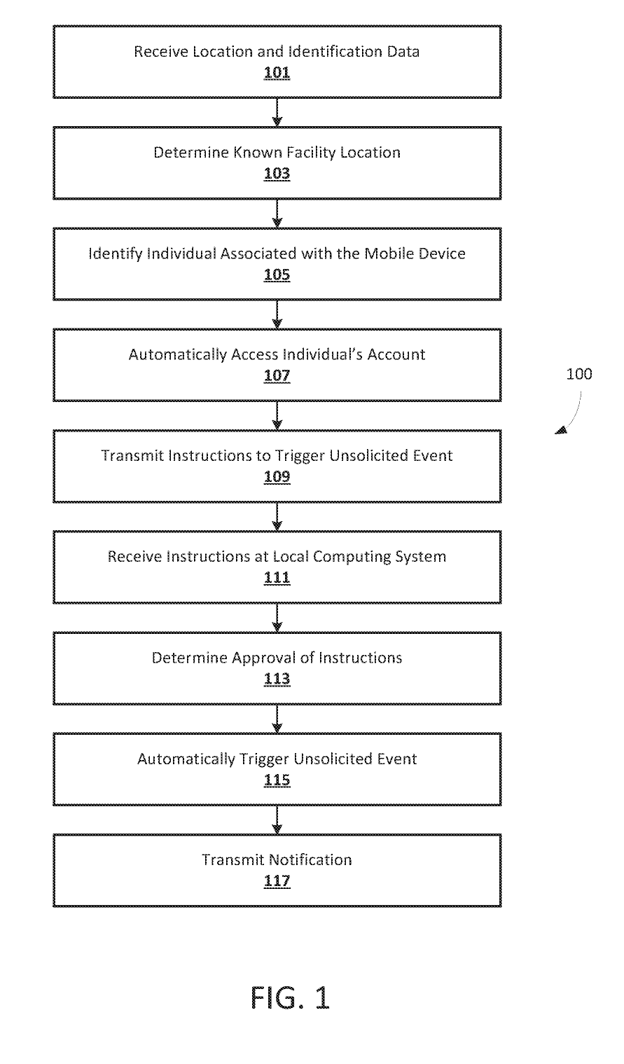

FIG. 1 is a flowchart illustrating an exemplary method 100 for automatically triggering predictive events in response to user detection, according to an exemplary embodiment. It will be appreciated that the method is programmatically performed, at least in part, by one or more computer-executable processes executing on, or in communication with one or more servers described further below. In step 101, location data and identification data associated with a mobile electronic device is received at a remote computing system. In some embodiments, the location data and identification data can be received via a scanning device located at an entrance to a facility, a Wi-Fi signal source (e.g., a wireless access point, such as a wireless router or hub) that can communicate with the mobile electronic device, using geo-fencing techniques, or using some other geolocation technology. For example, a GPS enabled mobile electronic device can be detected entering a facility, and identification information can also be collected from the mobile electronic device and transmitted to a remote computing system. In some embodiments, a user of the mobile electronic device can opt in or out of a mobile app or program configured to notify the computing system whenever the user approaches or enters a particular facility. In one embodiment, the location data and identification device can be detected in response to the user executing a mobile application associated with the remote computing system.

In step 103, the remote computing system determines that the location data associated with the mobile electronic device corresponds to a known facility location. In exemplary embodiments, the remote computing system can include or have access to a database with the locations of various facilities, and the location data associated with the mobile electronic device can be matched with the correct facility location. This data can indicate to the remote computing system the precise or estimated location of the individual associated with the mobile electronic device.

In step 105, the individual associated with the mobile electronic device is identified based on the identification data received in step 101. In some embodiments, the individual associated with the mobile electronic device can create a personalized account online or using a mobile app, and can configure the mobile electronic device to provide identifying information whenever the individual enters or approaches specified facilities.

In step 107, the remote computing system automatically accesses an account associated with the individual associated with the mobile electronic device upon identifying the individual based on the identification data. In some embodiments, the individual's account can include personal account data including previous activity data or past interaction data, such as data relating to previous interaction between the user and the facility. In some embodiments, previous activity data or past interaction data can include the identities of items or services provided to or retrieved by the individual, quantities of items retrieved by the individual, or retrieval times of items or services retrieved by the individual. As a non-limiting example, for embodiments in which the facility is a retail or service facility, the previous activity data can include a type and amount of meat that the individual typically gets from a deli counter on a weekly basis, or the type of oil the individual purchases for a regularly scheduled vehicle oil change.

In step 109, the remote computing system transmits instructions to trigger a predictive event at the facility location based on the location data and the previous activity data. In some embodiments, the predictive event can include the control of an autonomous system. As a non-limiting example, for embodiments in which the facility is a retail facility, the event can include the preparation of a particular amount of deli meat at a deli department, or the preparation of some other product or service that the individual is expected to request. This predictive event can be determined, in some embodiments, based on the previous activity data retrieved from the individual's account in step 107.

In step 111, a local computing system at the known facility location receives the instructions transmitted by the remote computing device in step 109. Once the instructions are received, the local computing system determines in step 113 whether to approve the instructions and trigger the predictive event. In some embodiments, the determination whether to approve the instructions and trigger the predictive event can be based on contemporaneously determined factors associated with the facility and resources associated with the facility. For example, the local computing system can determine an availability of computing resources, machines and equipment, and other resources to complete the event in a specified time period based on a particular time when the individual arrives at the facility. As a non-limiting example, for embodiments in which the facility is a retail facility, the local computing system can access an inventory system to confirm the availability of items required for the completion of the predictive event.

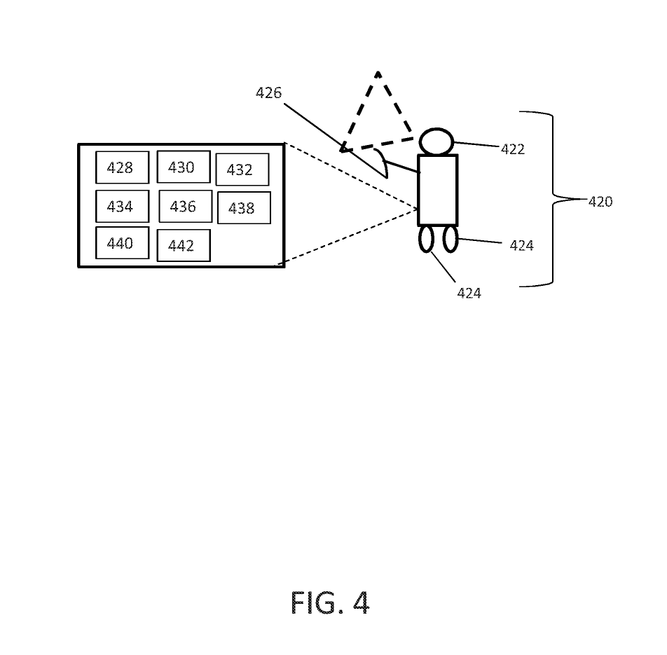

In step 115, the local computing system automatically triggers the predictive event in response to approval of the instructions. In some embodiments, the local computing system can control one or more autonomous systems to perform one or more actions. As one example, for in embodiments in which the facility is a retail facility, if the predictive event involves the preparation of a particular amount of deli meat, and the inventory database indicates that the particular deli meat is available and the machines and other resources are available to prepare the deli meat with a specified time period, the local computing system can transmit a instructions to the machines (e.g., slicing machines) to facilitate the preparation of a particular amount of the deli meat. In one embodiment, an autonomous robot device can complete the execution of the predictive event, in response to the remote computing systems instructions. The autonomous robot device will be described in further detail with respect to FIG. 4.

In step 117, the local computing system transmits a notification to the mobile electronic device once the predictive event is triggered and/or completed. For example, if the predictive event includes the preparation of a particular amount of deli meat, the notification can include a message notifying the individual associated with the mobile electronic device that their typical order of deli meat is available for retrieval. In another example, if the predictive event includes the preparation of a particular type of motor oil for a vehicle oil change, the notification can include a message notifying the individual that an automotive center is ready to receive the individual's vehicle for service. The various notifications described herein can be transmitted directly to a phone number, or through an application running on the mobile electronic device.

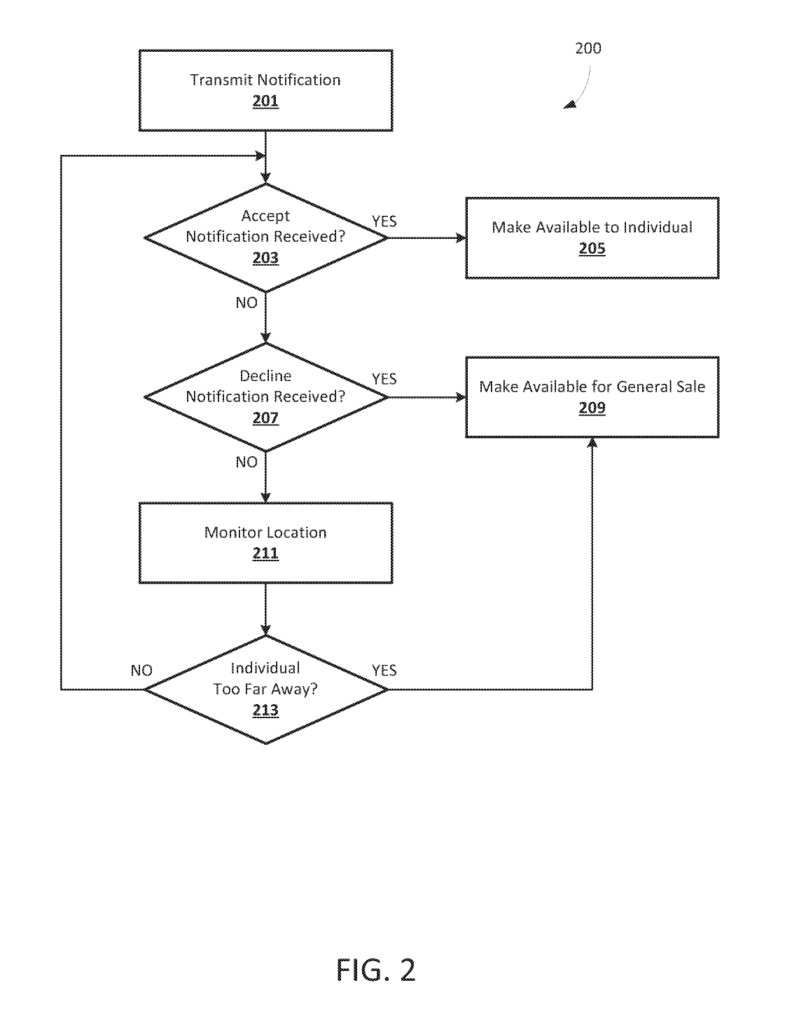

FIG. 2 is a flowchart illustrating an exemplary method 200 for automatically triggering predictive events in response to user detection, according to an exemplary embodiment. It will be appreciated that the method is programmatically performed, at least in part, by one or more computer-executable processes executing on, or in communication with one or more servers described further below. In step 201, a first notification is transmitted to the mobile electronic device associated with an individual, as described above in step 113. This notification can include a message indicating that a particular product or service is available to the individual.

In step 203, the local computing system determines whether a notification has been received from the mobile electronic device indicating that the individual accepts the available product or service. In some embodiments, a mobile application can indicate to the individual the availability of the product or service and allow the individual to accept or decline the product or service using a graphical user interface displayed via the mobile electronic device. If the individual accepts the product or service, the method can proceed to step 205, where the product or service is made available to the individual. For example, if the product includes a particular quantity of meat or cheese from a deli counter, the packaged meat or cheese can be placed at a pick-up location where the individual can easily identify and retrieve the prepared product.

If no acceptance notification has been received in step 203, the method can proceed with step 207, where the local computing system determines whether a notification has been received from the mobile electronic device indicating that the individual declines the available product or service. If the product or service is declined, the method can continue with step 209 and the prepared product or service can be made available for general sale. For example, if the individual receives a message indicating that a particular amount of deli meat has been prepared, but the individual declines the prepared deli meat, the prepared meat can be made available for general sale at the deli counter.

If no notification is received from the mobile electronic device in steps 203 and 207, the method can monitor the location of the mobile electronic device in step 211. In some embodiments, the geographical location of the mobile electronic device can be monitored using GPS technology, a Wi-Fi signal, geo-fencing technology, or any other suitable geolocation technology. In some embodiments, the local computing system can determine that the individual associated with the mobile electronic device is likely to decline the prepared product based on the geographical location of the mobile electronic device. For example, if the local computing system detects that the mobile electronic device has left the store, and then it may determine that the individual is unlikely to accept the prepared product or service. If it is determined in step 213 that the individual is too far away, the method can continue with step 209 and the prepared product or service can be made available to the general public. If, however, the individual is not too far away, the method can continue to monitor notifications from the mobile electronic device at step 203.

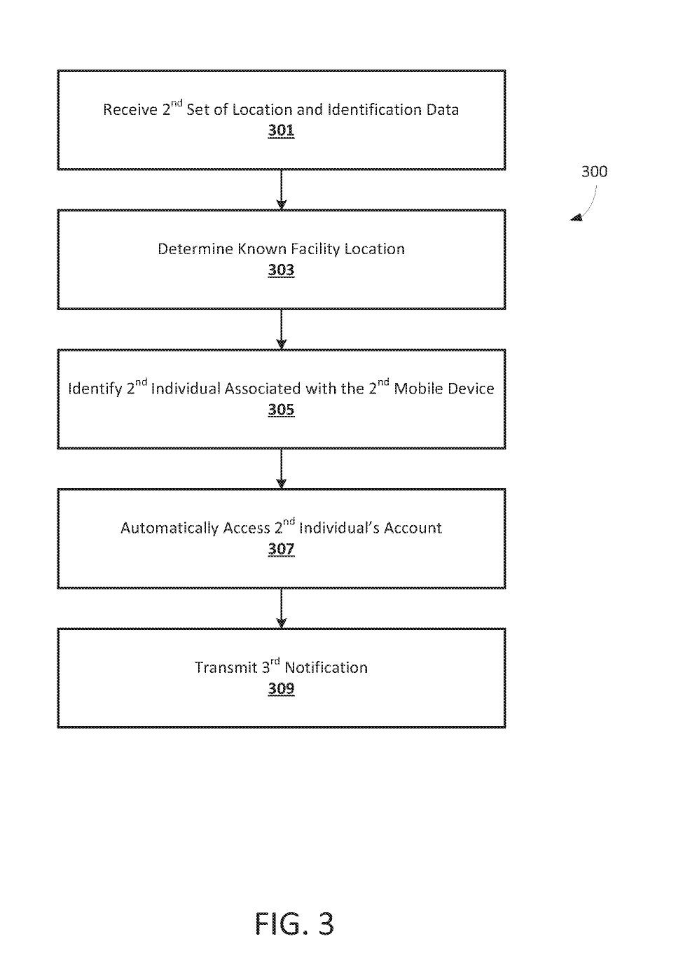

FIG. 3 is a flowchart illustrating an exemplary method 300 for automatically triggering predictive events in response to user detection, according to an exemplary embodiment. It will be appreciated that the method is programmatically performed, at least in part, by one or more computer-executable processes executing on, or in communication with one or more servers described further below. This exemplary method 300 can be implemented, in some embodiments, after completing one or more of the methods described in FIG. 1 and/or FIG. 2. In step 301, a second set of location data and identification data associated with a second mobile electronic device is received at a remote computing system. In some embodiments, the location data and identification data can be received via a scanning device located at an entrance to a facility, using geo-fencing techniques, or some other geolocation technology. For example, the second mobile electronic device can be GPS enabled, and can be detected upon entering a store. Identification information can also be collected from the second mobile electronic device and transmitted to a remote computing system. In some embodiments, a user of the second mobile electronic device can opt in or out of a mobile app or program configured to notify the computing system whenever the user approaches or enters a particular facility. In one embodiment, the second set of location data can be detected based on the second mobile device executing an application associated with the remote computing system.

In step 303, the remote computing system determines that the second set of location data associated with the second mobile electronic device corresponds to the known facility location. As discussed above, the remote computing system can have access to a database with the locations of various facilities. In other embodiments, the second mobile electronic device can actively transmit its location, along with the known facility location, to the remote computing system.

In step 305, the second individual/user associated with the second mobile electronic device is identified based on the second set of identification data received in step 301. In some embodiments, the second individual can be identified based on a personalized account or a mobile application running on the second mobile electronic device.

In step 307, the remote computing system automatically accesses an account associated with the second individual upon identifying the second individual. In some embodiments, the second individual's account can include personal account data including previous activity data or past interaction data, such as data relating to previous interaction between the second individual and the facility. In some embodiments, previous activity data or past interaction data can include the identities of items or services provided to or retrieved by the second individual, quantities of items retrieved by the second individual, or retrieval times of items or services retrieved by the second individual. As a non-limiting example, for embodiments in which the facility is a retail or service facility, previous activity data, such as data relating to the identities of items or services retrieved by the second individual, quantities of items retrieved by the second individual, or retrieval times of items or services retrieved by the second individual. In some embodiments, where the first individual has not retrieved a prepared product, the information contained in the second individual's account can indicate that the second individual is likely to want to purchase the prepared product. In such embodiments, rather than perform triggering another (or second) event, the local computing device can notify the second individual about the outcome of the first event. For example, instead of making the prepared product or service available for general consumption, as discussed in step 209, a notification can be transmitted to the second mobile electronic device in step 309 indicating that the prepared product is available for retrieval by the second individual.

FIG. 4 is a block diagram illustrating an autonomous robot device according to exemplary embodiments of the present disclosure. The autonomous robot device 420 can be a driverless vehicle, an unmanned aerial craft, automated conveying belt or system of conveyor belts, and/or the like. Embodiments of the autonomous robot device 420 can include an image capturing device 422, motive assemblies 424, a picking unit 426, a controller 428, an optical scanner 430, a drive motor 432, a GPS receiver 434, accelerometer 436 and a gyroscope 438, and can be configured to roam autonomously through the facility 400. The picking unit 426 can be an articulated arm. The autonomous robot device 420 can be an intelligent device capable of performing tasks without human control. The controller 428 can be programmed to control an operation of the image capturing device 422, the optical scanner 430, the drive motor 432, the motive assemblies 424 (e.g., via the drive motor 432), in response to various inputs including inputs from the GPS receiver 434, the accelerometer 436, and the gyroscope 438. The drive motor 432 can control the operation of the motive assemblies 424 directly and/or through one or more drive trains (e.g., gear assemblies and/or belts). In this non-limiting example, the motive assemblies 424 are wheels affixed to the bottom end of the autonomous robot device 420. The motive assemblies 424 can be but are not limited to wheels, tracks, rotors, rotors with blades, and propellers. The motive assemblies 424 can facilitate 360 degree movement for the autonomous robot device 420. The image capturing device 422 can be a still image camera or a moving image camera.

The GPS receiver 434 can be a L-band radio processor capable of solving the navigation equations in order to determine a position of the autonomous robot device 420, determine a velocity and precise time (PVT) by processing the signal broadcasted by GPS satellites. The accelerometer 436 and gyroscope 438 can determine the direction, orientation, position, acceleration, velocity, tilt, pitch, yaw, and roll of the autonomous robot device 420. In exemplary embodiments, the controller can implement one or more algorithms, such as a Kalman filter, for determining a position of the autonomous robot device.

The autonomous robot device 420 can further include a transceiver 442. The autonomous robot device 420 can receive and transmit information via the transceiver 442. As an example, the autonomous robot device 420 can receive instructions to execute an event based on instructions received from a remote computing system, via the transceiver 442.

As described above, the autonomous robot device 420 can execute an event in response to receiving instructions from a remote computing system. As one example, in embodiments in which the facility is a retail facility, if the predictive event involves the preparation of a particular amount of deli meat, and the inventory database indicates that the particular deli meat is available, and the machines and other resources are available to prepare the deli meat with a specified time period, the local computing system can transmit instructions to the machines (e.g., slicing machines) to facilitate the preparation of a particular amount of the deli meat. As another example, the event can involve retrieving products from the retail store for a user. The autonomous robot device 420 can autonomously navigate to a specified location in the retail store. The autonomous robot device 420 can use the optical scanner 430 and/or image capturing device 422 to scan an identifier of the products. The autonomous robot device 420 can identify the products based on the scanning of the identifier. The autonomous robot device 420 can pick up the products using the picking unit 426 and transport the products to a user or another specified location.

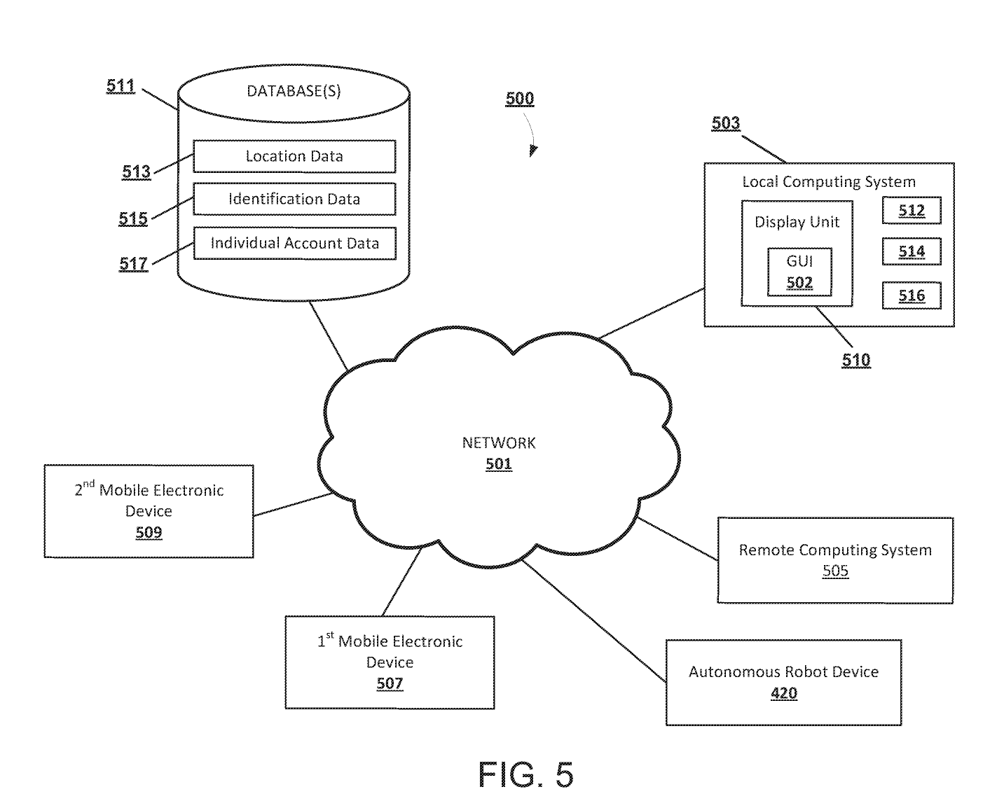

FIG. 5 illustrates a network diagram depicting a system 500 suitable for a distributed implementation of an exemplary embodiment. The system 500 can include a network 501, a local computing system 503, a remote computing system 505, a first mobile electronic device 507, a second mobile electronic device 509, an autonomous robot device 420, and a database 511. The local computing system 503 and the remote computing system 505 can be in communication with the first mobile electronic device 507, the second mobile electronic device 509, an autonomous robot device 420 and with each other over the network 501. As will be appreciated, various distributed or centralized configurations may be implemented without departing from the scope of the present invention. The database 511 can store the location data 513, identification data 515, and the individual account data 517, as discussed herein.

In exemplary embodiments, the local computing system 503 may include a display unit 510, which can display a GUI 502 to a user of the local computing system 503. In some embodiments, the local computing system 503 can display instructions to trigger the predictive event, as discussed above. The local computing system 503 can also include a memory 512, processor 514, and a wireless interface 516. In some embodiments, the local computing system 503 may include, but is not limited to, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, multi-processor systems, microprocessor-based or programmable consumer electronics, game consoles, network PCs, mini-computers, smartphones, and the like.

The local computing system 503, remote computing system 505, first mobile electronic device 507, second mobile electronic device 509, an autonomous robot device 420, may connect to the network 501 via a wireless connection, and the local computing system 503, and/or first and second mobile electronic devices 507, 509 may include one or more applications such as, but not limited to, a web browser, a geo-location application, and the like. The local computing system 503 may include some or all components described in relation to computing device 500 shown in FIG. 5.

The communication network 501 may include, but is not limited to, the Internet, an intranet, a LAN (Local Area Network), a WAN (Wide Area Network), a MAN (Metropolitan Area Network), a wireless network, an optical network, and the like. In one embodiment, the local computing system 503, remote computing system 505, first mobile electronic device 507, second mobile electronic device 509, and database 511 can transmit instructions to each other over the communication network 501. In exemplary embodiments, the location data 513, identification data 515, and individual account data 517 can be stored at the database 511 and received at the local computing system 503, remote computing system 505, first mobile electronic device 507, the second mobile electronic device 509, the autonomous robot device 420 in response to a service performed by a database retrieval application.

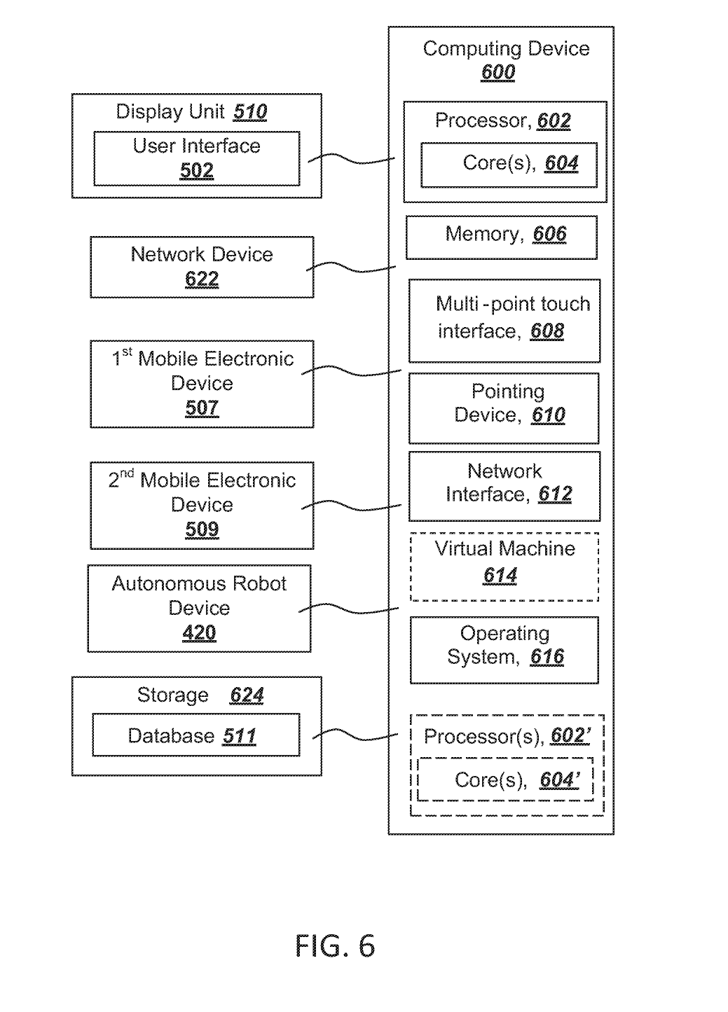

FIG. 6 is a block diagram of an exemplary computing device 600 that can be used in the performance of the methods described herein. The computing device 600 includes one or more non-transitory computer-readable media for storing one or more computer-executable instructions (such as but not limited to software or firmware) for implementing any example method according to the principles described herein. The non-transitory computer-readable media can include, but are not limited to, one or more types of hardware memory, non-transitory tangible media (for example, one or more magnetic storage disks, one or more optical disks, one or more USB flashdrives), and the like.

For example, memory 606 included in the computing device 600 can store computer-readable and computer-executable instructions or software for implementing exemplary embodiments and programmed to perform processes described above in reference to FIGS. 1-3. The computing device 600 also includes processor 602 and associated core 604, and optionally, one or more additional processor(s) 602′ and associated core(s) 604′ (for example, in the case of computer systems having multiple processors/cores), for executing computer-readable and computer-executable instructions or software stored in the memory 606 and other programs for controlling system hardware. Processor 602 and processor(s) 602′ can each be a single core processor or multiple core (604 and 604′) processor.

Virtualization can be employed in the computing device 600 so that infrastructure and resources in the computing device can be shared dynamically. A virtual machine 614 can be provided to handle a process running on multiple processors so that the process appears to be using only one computing resource rather than multiple computing resources. Multiple virtual machines can also be used with one processor.

Memory 606 can be non-transitory computer-readable media including a computer system memory or random access memory, such as DRAM, SRAM, EDO RAM, and the like. Memory 606 can include other types of memory as well, or combinations thereof.

A user can interact with the computing device 600 through a display unit 510, such as a touch screen display or computer monitor, which can display one or more user interfaces 502 that can be provided in accordance with exemplary embodiments. In some embodiments, the display unit 510 can also display instructions to trigger the predictive event, as disclosed herein. The computing device 600 can also include other I/O devices for receiving input from a user, for example, a keyboard or any suitable multi-point touch interface 608, a pointing device 610 (e.g., a pen, stylus, mouse, or trackpad). The multi-point touch interface 608 and the pointing device 610 can be coupled to the display unit 510. The computing device 600 can include other suitable conventional I/O peripherals.

The computing device 600 can also include one or more storage devices 624, such as a hard-drive, CD-ROM, or other non-transitory computer readable media, for storing data and computer-readable instructions and/or software that can implement exemplary embodiments of the methods and systems as taught herein, or portions thereof. Exemplary storage device 624 can also store one or more databases 511 for storing any suitable information required to implement exemplary embodiments. The database 511 can be updated by a user or automatically at any suitable time to add, delete, or update one or more items in the databases. Exemplary storage device 624 can store a database 511 for storing the location data 513, identification data 615, individual account data 617, and any other data/information used to implement exemplary embodiments of the systems and methods described herein.

The computing device 600 can also be in communication with the first mobile electronic device 507, the second mobile electronic device 509, and the autonomous robot device 420. In exemplary embodiments, the computing device 600 can include a network interface 612 configured to interface via one or more network devices 622 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 612 can include a built-in network adapter, network interface card, PCMCIA network card, card bus network adapter, wireless network adapter, USB network adapter, modem or any other device suitable for interfacing the computing device 600 to any type of network capable of communication and performing the operations described herein. Moreover, the computing device 600 can be any computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 600 can run operating system 616, such as versions of the Microsoft® Windows® operating systems, different releases of the Unix and Linux operating systems, versions of the MacOS® for Macintosh computers, embedded operating systems, real-time operating systems, open source operating systems, proprietary operating systems, operating systems for mobile computing devices, or other operating systems capable of running on the computing device and performing the operations described herein. In exemplary embodiments, the operating system 616 can be run in native mode or emulated mode. In an exemplary embodiment, the operating system 616 can be run on one or more cloud machine instances.

In describing example embodiments, specific terminology is used for the sake of clarity. For purposes of description, each specific term is intended to at least include all technical and functional equivalents that operate in a similar manner to accomplish a similar purpose. Additionally, in some instances where a particular example embodiment includes system elements, device components or method steps, those elements, components or steps can be replaced with a single element, component or step. Likewise, a single element, component or step can be replaced with multiple elements, components or steps that serve the same purpose. Moreover, while example embodiments have been shown and described with references to particular embodiments thereof, those of ordinary skill in the art will understand that various substitutions and alterations in form and detail can be made therein without departing from the scope of the disclosure. Further still, other aspects, functions and advantages are also within the scope of the disclosure.

Example flowcharts are provided herein for illustrative purposes and are non-limiting examples of methods. One of ordinary skill in the art will recognize that example methods can include more or fewer steps than those illustrated in the example flowcharts, and that the steps in the example flowcharts can be performed in a different order than the order shown in the illustrative flowcharts.

What is claimed is:

1. A system for automatically triggering predictive events in a facility in response to user detection, the system comprising:
(a) a remote computing system configured to receive location data and identification data associated with a mobile device, the remote computing system configured to:
(i) determine that the location data associated with the mobile device corresponds to a facility location known to the remote computing system;
(ii) identify an individual associated with the mobile device based on the identification data;
(iii) automatically access an account associated with the individual upon identifying the individual, the account including previous activity data of the individual; and
(iv) transmit instructions to trigger a predictive event at a facility based on the location data and the previous activity data; and
(b) a local computing system disposed at the facility corresponding to the facility location, the local computing system being configured to:
(i) receive the instructions from the remote computing system;
(ii) determine whether to approve the instructions based on contemporaneously determined factors associated with the facility;
(iii) automatically trigger the predictive event in response to approval of the instructions; and
(iv) transmit a notification to the mobile device in response to completion of the predictive event.

2. The system of claim 1, wherein the local computing system is further configured to:
access an inventory system to confirm availability of items required for completion of the predictive event.

3. The system of claim 1, wherein the local computing system is further configured to:
receive a second notification from the mobile device indicating whether the individual accepts or declines a result of completing the predictive event.

4. The system of claim 1, wherein the local computing system is further configured to:
monitor a geographical location of the mobile device; and
determine that the individual associated with the mobile device is likely to decline the predictive event based on the geographical location of the mobile device.

5. The system of claim 1, wherein the contemporaneously determined factors include an availability of items or machines required for completion of the predictive event at a time the individual arrives at the facility.

6. The system of claim 1, wherein the remote computing system is further configured to:
receive a second set of location data and a second set of identification data associated with a second mobile device;
determine that the second set of location data corresponds to the facility location known to the remote computing system;
identify a second individual associated with the second mobile device based on the second set of identification data; and
automatically access a second account associated with the second individual upon identifying the second individual, the second account including previous activity data of the second individual; and
wherein the local computing system is further configured to transmit a third notification to the second mobile device indicating completion of the predictive event.

7. The system of claim 1, wherein the previous activity data includes data relating to identities of items or services retrieved by the individual, quantities of items retrieved by the individual, or retrieval times of items or services retrieved by the individual.

8. A method for automatically triggering predictive events in a facility in response to user detection, the method comprising:
receiving location data and identification data associated with a mobile device at a remote computing system;
determining that the location data associated with the mobile device corresponds to a facility location known to the remote computing system;
identifying an individual associated with the mobile device based on the identification data;
automatically accessing an account associated with the individual upon identifying the individual, the account including previous activity data of the individual;
transmitting instructions to trigger a predictive event at the facility based on the location data and the previous activity data;
receiving the instructions at a local computing system disposed at the facility corresponding to the facility location;
determining whether to approve the instructions based on contemporaneously determined factors associated with the facility;
automatically triggering the predictive event in response to approval of the instructions; and
transmitting a notification from the local computing system to the mobile device, in response to completion of the predictive event.

9. The method of claim 8, further comprising:
accessing an inventory system, using the local computing system, to confirm availability of items required for completion of the predictive event.

10. The method of claim 8, further comprising:
receiving a second notification from the mobile device indicating whether the individual accepts or declines a result of completing the predictive event.

11. The method of claim 8, further comprising:
monitoring a geographical location of the mobile device; and
determining that the individual associated with the mobile device is likely to decline the predictive event based on the geographical location of the mobile device.

12. The method of claim 8, wherein the contemporaneously determined factors include an availability of items or machines required for completion of the predictive event at a time the individual arrives at the facility.

13. The method of claim 8, further comprising:
receiving a second set of location data and a second set of identification data associated with a second mobile device at the remote computing system;
determining that the second set of location data corresponds to the facility location known to the remote computing system;
identifying a second individual associated with the second mobile device based on the second set of identification data; and
automatically accessing a second account associated with the second individual upon identifying the second individual, the second account including previous activity data of the second individual; and
wherein the local computing system is further configured to transmit a third notification to the second mobile device indicating completion of the predictive event.

14. The method of claim 8, wherein the previous activity data includes data relating to identities of items or services retrieved by the individual, quantities of items retrieved by the individual, or retrieval times of items or services retrieved by the individual.

15. A non-transitory machine readable medium storing instructions executable by a processing device, wherein execution of the instructions causes the processing device to implement a method for automatically triggering predictive events in a facility in response to user detection, the method comprising:
receiving location data and identification data associated with a mobile device at a remote computing system;
determining that the location data associated with the mobile device corresponds to a facility location known to the remote computing system;
identifying an individual associated with the mobile device based on the identification data;
automatically accessing an account associated with the individual upon identifying the individual, the account including previous activity data of the individual;
transmitting instructions to trigger a predictive event at the facility based on the location data and the previous activity data;
receiving the instructions at a local computing system disposed at the facility corresponding to the facility location;
determining whether to approve the instructions based on contemporaneously determined factors associated with the facility;
automatically triggering the predictive event in response to approval of the instructions; and
transmitting a notification from the local computing system to the mobile device, in response to completion of the predictive event.

16. The non-transitory machine readable medium of claim 15, wherein execution of the instructions further causes the processing device to:
access an inventory system, using the local computing system, to confirm availability of items required for completion of the predictive event.

17. The non-transitory machine readable medium of claim 15, wherein execution of the instructions further causes the processing device to:
receive a second notification from the mobile device indicating whether the individual accepts or declines a result of completing the predictive event.

18. The non-transitory machine readable medium of claim 15, wherein execution of the instructions further causes the processing device to:
monitor a geographical location of the mobile device; and
determine that the individual associated with the mobile device is likely to decline the predictive event based on the geographical location of the mobile device.

19. The non-transitory machine readable medium of claim 15, wherein the contemporaneously determined factors include an availability of items or machines required for completion of the predictive event at a time the individual arrives at the facility.

20. The non-transitory machine readable medium of claim 15, wherein execution of the instructions further causes the processing device to:
receive a second set of location data and a second set of identification data associated with a second mobile device at the remote computing system;
determine that the second set of location data corresponds to the facility location known to the remote computing system;
identify a second individual associated with the second mobile device based on the second set of identification data; and
automatically access a second account associated with the second individual upon identifying the second individual, the second account including previous activity data of the second individual; and
wherein the local computing system is further configured to transmit a third notification to the second mobile device indicating completion of the predictive event.
